(19) United States
(12) Patent Application Publication
(10) Pub. No.: US 2001/0052750 A1
(43) Pub. Date: Dec. 20, 2001

(54) Color cathode ray tube and reinforcing band for color cathode ray tube

(75) Inventors: Yasushi Tanaka, Tokyo (JP); Hideki Matsuoka, Tokyo (JP); Kenji Tahara, Tokyo (JP); Susumu Kitajima, Osaka (JP); Hiromi Wakasono, Takarazuka-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: NKK Corporation, Tokyo (JP)

(21) Appl. No.: 09/874,592

(22) Filed: Jun. 5, 2001

(30) Foreign Application Priority Data
Jun. 12, 2000 (JP) 2000-175005

(51) Int. Cl. H01J 31/00

(52) U.S. Cl. 313/479

(57) ABSTRACT

Disclosed is a color cathode ray tube, comprising a glass bulb having a phosphor screen formed on the inner surface, a mask frame having a frame-like body arranged within the glass bulb, a shadow mask stretched between the mutually facing two sides of the mask frame, and a reinforcing band mounted to the outer circumferential surface of the glass bulb, wherein the reinforcing band exhibits a permeability μ falling within a range of between 430 and 640 under a magnetic field of 0.3 Oe.

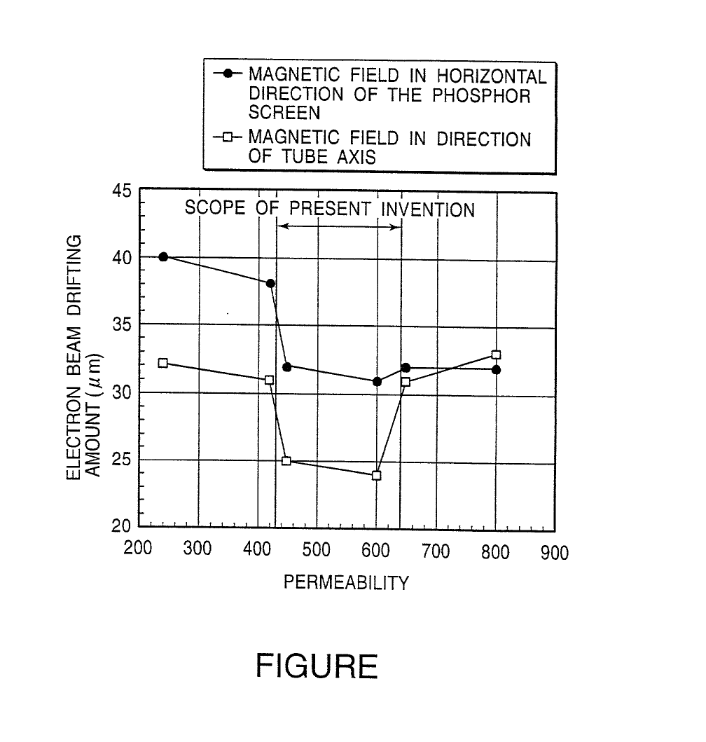

### BACKGROUND OF THE INVENTION

1. Field of the Invention

The present invention relates to a color cathode ray tube equipped with a shadow mask of the tension type and to a reinforcing band for a color cathode ray tube.

2. Description of the Related Art

Since the inner space of a color cathode ray tube is held under a high vacuum state of about 1.33×10⁻⁵ Pa (1.0×10⁻⁷ Torr), measures are taken to prevent the deformation of the panel plane and to prevent implosion of the tube. Employed as a measure for correcting the deformation of the panel plane is a so-called “shrink fit” treatment, in which a reinforcing band made of a steel sheet formed onto a band is heated and thermally expanded for several seconds to scores of seconds under a temperature range of about 400° C. to 600° C., followed by fitting the expanded steel band onto a glass panel of color cathode ray tube (hereinafter referred to simply as a “panel”) and subsequently cooling and shrinking the reinforcing band thereby imparting tension to the reinforced band. Like an inner magnetic shield, the reinforcing band performs the function of shielding the geomagnetism so as to prevent the deviation in the landing position of the electron beam on a phosphor screen, i.e., to prevent the color drift. Under the circumstances, it was customary in the past to use a mild steel for forming the reinforcing band.

Japanese Patent Disclosure (Kokai) No. 10-208670 discloses a method of manufacturing a reinforcing band capable of ensuring tension for correcting the deformation of the panel caused by the air pressure and exhibiting sufficient magnetic shielding properties. It is disclosed that the manufacturing method of the reinforcing band comprises the steps of preparing a steel containing not more than 0.005% by weight of C, 2.0% to 4.0% by weight of Si, 0.1% to 1.0% by weight of Mn, not more than 0.2% by weight of P, not more than 0.020% by weight of S, not more than 0.004% by weight or 0.1% to 1.0% by weight of Sol. Al, and not more than 0.005% by weight of N, subjecting the steel of the particular composition to a hot rolling and/or cold rolling process, annealing the rolled steel sheet at 700° C. to 900° C., and light rolling the annealed steel sheet under a cold rolling reduction of 3 to 15%. It is taught that the reinforcing band after the heating-cooling step, i.e., the shrink fit process, exhibits not smaller than 250 of a permeability μ under a magnetic field of 0.3 Oe, and not smaller than 40 kgf/mm² (392 MPa) of a yield stress YS.

This prior art certainly permits improving the permeability because the steel contains a large amount of Si. However, since Si is added in an amount of about 3% by weight, the mechanical strength is rendered excessively high, making it difficult to cope with the situation in the case where a yield stress YS not higher than 40 kfg/mm² (392 MPa) is required.

In order to overcome the above-noted difficulty, various efforts have been made in an attempt to develop a reinforcing band having an appropriate level of mechanical strength, which is sufficient for preventing the implosion problem, and sufficient magnetic shielding properties. Proposed, for example, Japanese Patent Disclosure No. 11-286726 is a steel sheet for a reinforcing band having a composition in which Si is not contained in a large amount, having a high permeability, and having an appropriate mechanical strength. The steel sheet disclosed in the prior art is featured in that the product μ×t, where μ represents the permeability under the magnetic field of 0.3 Oe after the shrink fit treatment, and t represents the thickness of the steel sheet, is at least 400.

However, the present inventors have applied a reinforcing band prepared on the basis of Japanese Patent Disclosure No. 11-286726 to a color cathode ray tube of a type in which tension is applied in a vertical direction to a flat type shadow mask during the use (hereinafter referred to “a one dimensional tension flat mask type”), for evaluating the amount of deviation of the landing position of the electron beam on the phosphor screen caused by the geomagnetism (hereinafter referred to “the electron beam drifting amount”). It has been found that, in the case of using a steel sheet having a permeability μ not smaller than 400, the electron beam drift amount is not stabilized, making it difficult to suppress the electron beam drifting amount without fail.

### BRIEF SUMMARY OF THE INVENTION

An object of the present invention is to provide a color cathode ray tube equipped with a reinforcing band capable of suppressing with a high stability the electron beam drifting amount caused by the geomagnetism and a reinforcing band for such a color cathode ray tube.

According to a first aspect of the present invention, there is provided a color cathode ray tube, comprising a glass bulb having a phosphor screen formed on the inner surface, a mask frame having a frame-like body arranged within the glass bulb, a shadow mask stretched between the mutually facing two sides of the mask frame, and a reinforcing band mounted to the outer circumferential surface of the glass bulb, wherein the reinforcing band exhibits a permeability μ falling within a range of between 430 and 640 under a magnetic field of 0.3 Oe.

According to another aspect of the present invention, there is provided a reinforcing band for a color cathode ray tube, in which a shadow mask is stretched between the mutually facing two sides of a frame-like mask frame arranged within a glass bulb having a phosphor screen formed on the inner surface, the reinforcing band being mounted to the outer circumferential surface of the glass bulb, wherein the reinforcing band exhibits a permeability falling within a range of between 430 and 640 under a magnetic field of 0.3 Oe.

According to the present invention, the permeability of the reinforcing band is set to fall within a range of between 430 and 640 under a magnetic field of 0.3 Oe in a color cathode ray tube of a one dimensional tension flat mask type, with the result that it is possible to shield effectively the geomagnetism and to suppress with a high stability the deviation of the landing position of the electron beam on the screen over the entire region of the phosphor screen.

### BRIEF DESCRIPTION OF THE DRAWING

The Single FIGURE is graph showing the relationship between the permeability of the reinforcing band and the electron beam drifting amount in a corner portion of the phosphor screen with respect to a color cathode ray tube according to examples of the present invention.

### DETAILED DESCRIPTION OF THE INVENTION

The present invention will now be described in detail.

As a result of an extensive research conducted in an attempt to achieve the object noted above, the present inventors have found that:

(1) In a color cathode ray tube of a one dimensional tension flat mask type, the electron beam drifting amount caused by the geomagnetism is increased if the permeability of the reinforcing band is excessively high, unlike the color cathode ray tube of a press mask type or an aperture grill type.

(2) The deterioration of the electron beam drifting amount is prominent in the case where the electron beam impinges on the corner portion of the phosphor screen particularly when the geomagnetism is applied in the direction of the tube axis.

The present invention of the particular construction has been achieved on the basis of the finding given above.

The cathode ray tube of the present invention is a color cathode ray tube comprising a glass bulb having a phosphor screen formed on the inner surface, a frame-like mask frame arranged within the glass bulb, a shadow mask stretched between the mutually facing two sides of the mask frame, and a reinforcing band mounted to the outer circumferential surface of the glass bulb. In the color cathode ray tube of the present invention, the reinforcing band is defined to exhibit a permeability of 430 to 640 under a magnetic field of 0.3 Oe. As a result, it is possible to suppress the electron beam drifting amount caused by the geomagnetism. The particular effect is rendered prominent in the case of, particularly, a color cathode ray tube of a one dimensional tension flat mask type. The phenomenon inherent in the present invention cannot be found in a color cathode ray tube of a press mask type or an aperture grill type.

In general, a steel sheet having a plating treatment applied thereto for preventing the rusting is used as the steel sheet of the reinforcing band exhibiting the prominent effect described above. In some cases, the steel sheet is slit and sheared in a predetermined size. Then, a folding treatment may be applied to the steel sheet so as to be formed in a folded state. Further, the steel sheet is formed to conform with the shape of the cathode ray tube and, then, the edge portion of the formed steel sheet is welded so as to form a reinforcing band. The reinforcing band thus prepared is heated to a predetermined temperature by a heating means such as a flame heating and induction heating so as to be thermally expanded. The reinforcing band under the expanded state is fitted onto a cathode ray tube, followed by cooling and shrinking the reinforcing band. As a result, the reinforcing band is mounted to the cathode ray tube in a manner to apply a compressive force to the cathode ray tube.

### EXAMPLE

The prominent effect of the present invention has been confirmed in the Example as follows.

Six kinds of reinforcing bands having a permeability of 240, 420, 450, 600, 650 and 800, respectively, and each having a thickness of 1.2 mm were mounted by a shrink fit treatment by the ordinary method to cathode ray tubes for 68 cm color television receivers of a one dimensional tension flat type manufactured by Matsushita Electric Industrial Co., Ltd. Each of these cathode ray tubes was incorporated in a television set for conducting an experiment to evaluate the electron beam drifting amount at each position of the phosphor screen, covering the case where a magnetic field of 0.3 Oe, which corresponds to that of the geomagnetism, was applied in the horizontal direction of the phosphor screen, and the case where the magnetic field noted above was applied in a direction of the tube axis. FIGURE is a graph showing the experimental data in respect of the relationship between the permeability of the reinforcing band and the electron beam drifting amount, covering the case where the magnetic field was applied in the horizontal direction of the phosphor screen and the case where the magnetic field was applied in a direction of the tube axis. In the graph of FIGURE, the permeability of the reinforcing band is plotted on the abscissa. Also, the horizontal component of the electron beam drifting amount in the corner portion of the screen is plotted on the ordinate of the graph.

As shown in FIGURE, where a magnetic field is applied in the horizontal direction of the phosphor screen, the electron beam drifting amount in the corner portion of the phosphor screen tends to be diminished with increase in the permeability of the reinforcing band. Particularly, the electron beam drifting amount is sharply decreased in the case where the permeability falls within a range of between 420 and 650. Also, in the case where a magnetic field is applied in a direction of the tube axis, the electron beam drifting amount is sharply decreased to reach the minimum value in the case where the permeability of the reinforcing band falls within a range of between 420 and 650.

The experimental data clearly support that it is possible to suppress the electron beam drifting amount by setting the permeability of the reinforcing band above 420 and below 650 in each of the cases where the magnetic field is applied in the horizontal direction of the phosphor screen and in a direction of the tube axis.

It should also be noted that the allowable value of the electron beam drifting amount in the cathode ray tube for a 68 cm color television set is 35 μm for the magnetic field in the horizontal direction of the phosphor screen and 30 μm for the magnetic field in the direction of the tube axis. As apparent from FIGURE, it has also been confirmed that the electron beam drifting amount can be made smaller than these allowable values by setting the permeability of the reinforcing band under a magnetic field of 0.3 Oe to fall within a range of between 430 and 640.

Incidentally, the particular effect of the present invention shown in FIGURE cannot be recognized in a color cathode ray tube of a press mask type or an aperture grill type and, thus, is inherent in a color cathode ray tube of the present invention, which is of a one dimensional tension flat mask type. Reasons for bringing about the particular phenomenon have not yet been clarified sufficiently. However, it is considered reasonable to understand that, if the permeability is excessively high, the reinforcing band is strongly magnetized by the magnetic field corresponding to the geomagnetism so as to form a magnetic pole conforming with the amount of the magnetization, with the result that the magnetic pole thus formed gives a detrimental effect to the electron beam drifting amount.

In the Example described above, the reinforcing band had a thickness of 1.2 mm. However, the thickness of the reinforcing band is not particularly limited, as far as the reinforcing band is lightweight and has a mechanical strength high enough to withstand the implosion. In other words, the particular effect of the present invention can be obtained even if the thickness of the reinforcing band is not particularly limited.

What is claimed is:

1. A color cathode ray tube, comprising a glass bulb having a phosphor screen formed on the inner surface, a mask frame having a frame-like body arranged within said glass bulb, a shadow mask stretched between the mutually facing two sides of said mask frame, and a reinforcing band mounted to the outer circumferential surface of said glass bulb, wherein said reinforcing band exhibits a permeability μ falling within a range of between 430 and 640 under a magnetic field of 0.3 Oe.

2. A reinforcing band for a color cathode ray tube, in which a shadow mask is stretched between the mutually facing two sides of a frame-like mask frame arranged within a glass bulb having a phosphor screen formed on the inner surface, said reinforcing band being mounted to the outer circumferential surface of said glass bulb, wherein said reinforcing band exhibits a permeability falling within a range of between 430 and 640 under a magnetic field of 0.3 Oe.
